(19) United States
(12) Patent Application Publication
(10) Pub. No.: US 2013/0191451 A1
(43) Pub. Date: Jul. 25, 2013

(54) Presence-based Synchronization

(71) Applicants: David Tse, Kirkland, WA (US); Sattawat Suppalertporn, Redmond, WA (US); Gary Neitzke, Duvall, WA (US); Suresh Sitaula, Bellevue, WA (US)

(72) Inventors: David Tse, Kirkland, WA (US); Sattawat Suppalertporn, Redmond, WA (US); Gary Neitzke, Duvall, WA (US); Suresh Sitaula, Bellevue, WA (US)

(73) Assignee: MICROSOFT CORPORATION, Redmond, WA (US)

(21) Appl. No.: 13/353,334

(22) Filed: Jan. 19, 2012

(51) Int. Cl. G06F 15/16

(52) U.S. Cl. 709/204

(57) ABSTRACT

Presence-based synchronization manages updates among concurrent collaborators based on the presence information of each collaborator within a shared document of a collaboration environment. A collaborator's edits to a page of a shared document can be synchronized more frequently when other collaborators are accessing the same page. In contrast, the collaborator's edits to a page of a shared document can be synchronized less frequently when no other collaborators are accessing that page. Further, the manner of the collaborator's presence within the shared document may influence the synchronization rate—collaborating users within an online meeting may synchronize more frequently than a single user who is not actively collaborating with other users. In one implementation, other maintenance activities within the shared document (e.g., garbage collection) may be influenced by the presence information of collaborators within the collaboration environment.

### BACKGROUND

Online collaboration tools can often inform a user about the status or “presence” of other users within the collaboration environment. For example, an instant messaging tool can indicate whether another user is logged in, is actively engaged in an online communication with someone else in the collaboration environment, has been inactive at his or her computer for an extended period of time, etc. Such indications of “presence” can be helpful in allowing one user to know whether another user is available for online communications.

Further, some online collaboration tools allow multiple users to edit a shared document concurrently. In some environments, for example, the shared document may represent a very large data repository of all information pertaining to a development group's project. Such an online collaboration tool can synchronize the editing activity among multiple users. However, such synchronizations can fail to achieve a “real-time-enough” collaboration experience (e.g., a user may judge edits by other users in a shared document to be synchronized too slowly). Alternatively, such synchronization can generate more network activity within the collaboration environment than necessary or desirable (e.g., non-trivially impacting network and server loads and potentially diminishing the sense of currency within the collaboration environment).

### SUMMARY

Implementations described and claimed herein address the foregoing problems by synchronizing updates among concurrent collaborators based on the presence information of each collaborator within a shared document of a collaboration environment. A collaborator's edits to a page of a shared document can be synchronized more frequently when other collaborators are accessing the same page. In contrast, the collaborator's edits to a page of a shared document can be synchronized less frequently when no other collaborators are accessing that page. Further, the manner of the collaborator's presence within the shared document may influence the synchronization rate—collaborating users within an online meeting may synchronize more frequently than a single user who is not actively collaborating with other users. In one implementation, other maintenance activities within the shared document (e.g., garbage collection) may be influenced by the presence information of collaborators within the collaboration environment.

Other implementations are also described and recited herein.

### BRIEF DESCRIPTIONS OF THE DRAWINGS

FIG. 1 illustrates an example collaboration environment providing presence-based synchronization.

FIG. 2 illustrates a screenshot from an example collaboration environment providing presence-based synchronization.

FIG. 3 illustrates an example collaboration environment providing presence-based synchronization at a base synchronization rate.

FIG. 4 illustrates an example collaboration environment providing presence-based synchronization at a variety of synchronization rates.

FIG. 5 illustrates example operations for determining between a single user mode and a multi-user mode for presence-based synchronization.

FIG. 6 illustrates example operations for executing a multi-user mode for presence-based synchronization, transitioning from a standard sync mode to a fast sync mode.

FIG. 7 illustrates example operations for executing a multi-user mode for presence-based synchronization, transitioning from a fast sync mode to a standard sync mode.

FIG. 8 illustrates an example system that may be useful in implementing the technology described herein.

### DETAILED DESCRIPTIONS

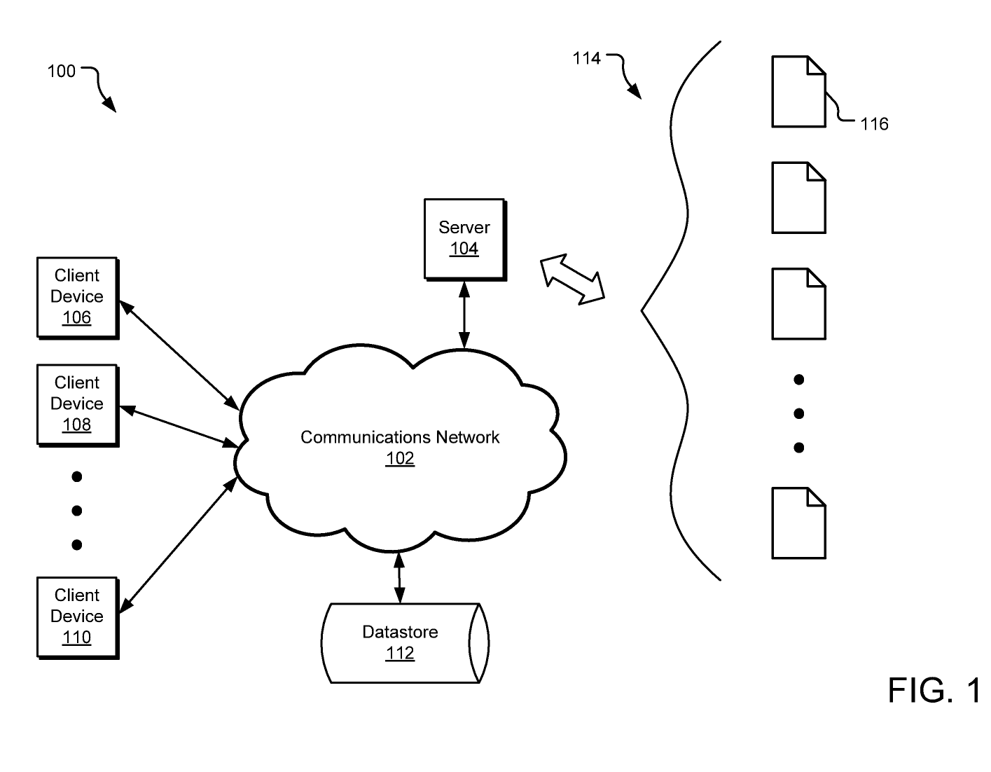

FIG. 1 illustrates an example collaboration environment 100 providing presence-based synchronization. The collaboration environment 100 includes a communications network 102 communicatively coupling a collaboration server 104, a plurality of client devices 106, 108, 110, etc., and a datastore 112. The datastore 112 stores shared documents accessible within the collaboration environment 100, access to which is managed by the collaboration server 104. Collaborators (e.g., users concurrently accessing a shared document 114) use the client devices 106, 108, and 110 to access the shared document stored in the datastore 122 via the collaboration server 104. Through this connection, users may collaborate with other users within the shared document 114. The shared document 114 may be a single document file or a collection of document files with various levels of subdivision (e.g., notebooks, sub-documents, sections, pages, paragraphs, sections, etc.). In one implementation, for example, the shared document 114 can include a large collection of information pertaining to a particular project, including personnel data, requirements specifications, functional specifications, design specifications, release schedules, online discussion logs, emails, project plans, blueprints, source code, artwork, notes, etc. As such, a shared document need not be limited to a single document file.

In the collaboration environment 100, the client devices of collaborators provide and receive update communications reflecting accesses to the shared document 114 at frequencies determined based on the relative presence information of the other collaborators within the collaboration environment 100. For example, collaborators concurrently accessing the same page 116 of the shared document 114 may be synchronized more frequently with other collaborators on that page than with other collaborators on other pages. In this manner, the collaborators on the same page experience a rapid synchronization of edits by other collaborators on that page, such that those edits appear on the page in a very fast or real time fashion. In contrast, those collaborators not on the same page 116 would not view the edits to that page until they navigate to that page. As such, edits on that page can be synchronized to these “distant” collaborators less frequently, thereby reducing the average synchronization traffic within the collaboration environment 100.

Update communications provide indications of user presence information within the collaboration environment 100, including without limitation user behavior, user status, editing actions, active/inactive status or other status indicators (e.g., implicit or explicit status), location within the shared document, frequency of active edits, whether the user is in an online meeting, identities of the other users with whom a collaborator is communicating, whether user is active within the collaboration environment or whether the user has the collaboration environment executing in the background, geographical location (GPS) data, the user's identity (including federated identity), etc.

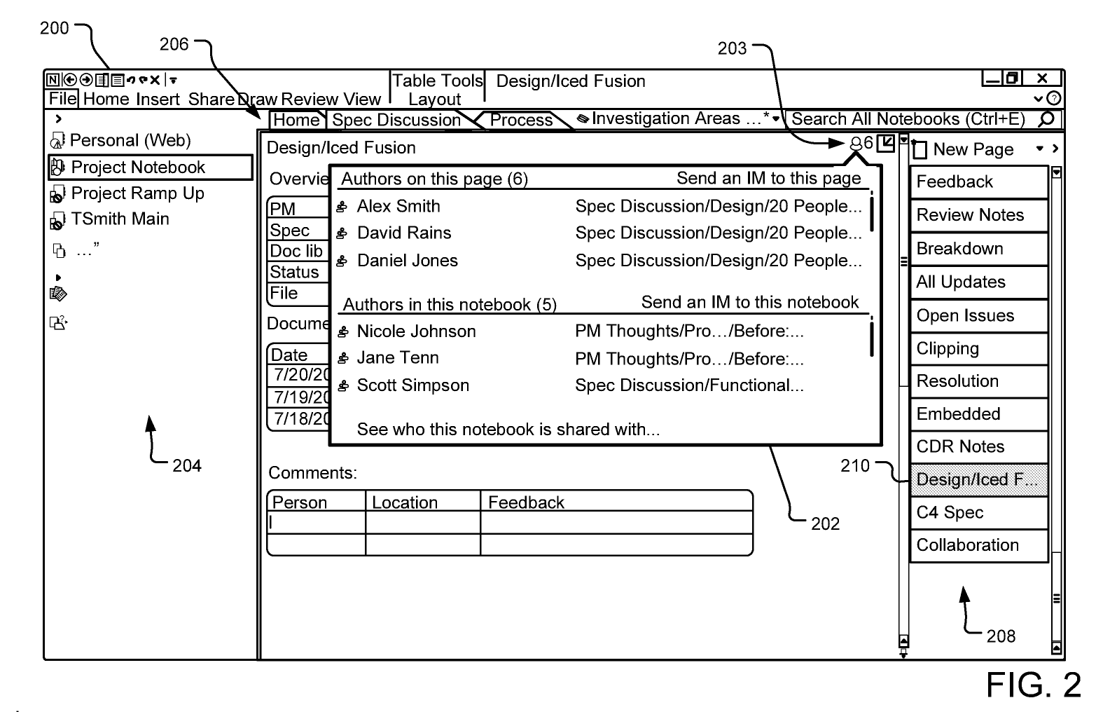

FIG. 2 illustrates a screenshot 200 from an example collaboration environment providing presence-based synchronization. The callout 202 in the screenshot 200, which is displayed by hovering over or selecting the icon 203, displays the names of collaborators within a shared document called “Spec Discussion”, and specifically within a notebook called “Project Notebook,” with 11 people in the “Project Notebook” notebook and 6 people on the page Design/Iced Fusion page of the Project Notebook. The listing 204 along the left sidebar indicates multiple notebooks available within the shared document. The tabs along the top of the screenshot 200 indicate various sections within the notebook. The listing 208 along the right sidebar indicates multiple pages within the notebook, with the current page 210 being highlighted in the sidebar.

Of eleven collaborators accessing the Project Notebook notebook, six of them are accessing the current page displayed in the screenshot. Presence on the same page may suggest more active collaboration activities among the collaborators than with those on other pages, and therefore these six collaborators synchronize more frequently with each other than with the other five collaborators currently present on other pages.

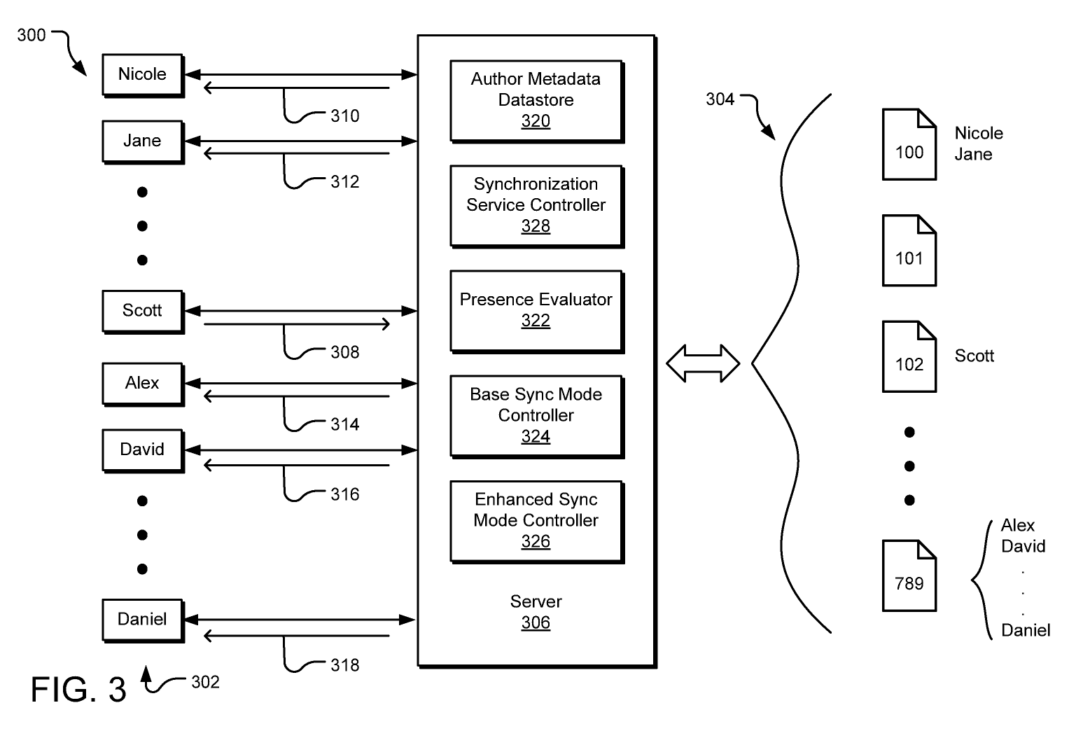

FIG. 3 illustrates an example collaboration environment 300 providing presence-based synchronization at a base synchronization rate. Collaborators 302 are concurrently accessing the shared document 304. Nicole and Jane are concurrently accessing page 100, while Scott is accessing page 102 and Alex, David, Daniel and others are accessing page 789. Other collaborators (not shown) may also be accessing the shared document 304. If only a single collaborator was currently accessing the shared document 304, the presence-based synchronization operation would be in a single user mode. However, as multiple collaborators are concurrently accessing the shared document 304, albeit in a variety of locations within the shared document 304, the presence-based synchronization operation is in a multi-user mode.

Within the multi-user mode, Scott's accesses to a page (i.e., page 102) that is not concurrently accessed by other collaborators causes Scott's access operations (e.g., edits) to that page to be updated to a collaboration server 306 on a base update communications frequency. As such, Scott's client device sends update communications describing his edits at the base update communications frequency indicated by the arrow 308). Likewise, Scott's receipt of edit updates (not shown) by other collaborators on other pages within the shared document 304 is also scheduled on a base update communications frequency. It should be understood that base update frequencies to and from the collaboration server 306 may differ, depending on the configuration of the collaboration environment 300.

As shown in FIG. 3, the other collaborators also receive Scott's edit updates at a base update communications frequency (as shown by arrows 310, 312, 314, 316, and 318) because these collaborators are not present on or accessing the same page (page 102) as Scott. It should be understood that base update frequencies, whether to or from the server, may be customized on a per user basis.

In one implementation, the collaboration server 306 includes or has access to an author metadata datastore 320, which can store author metadata (including without limitation location data, activity status, communication capability data, etc.) on a per document or document subdivision basis for each collaborator. Location data may indicate the location of access by a collaborator within the shared document. Activity status may indicate whether the collaborator is actively accessing the shared document, as opposed to having the document open in a background process. Communication capability data may indicate the communication bandwidth available between the collaboration server and a client device. Other author metadata may be employed.

A presence evaluator 322 determines whether a presence condition is satisfied by one or more other collaborators relative to the current collaborator. A base sync mode controller 324 manages the update communications with the client devices of the concurrent collaborators during a base sync mode, and an enhanced sync mode controller 326 manages the update communications with the client devices of the concurrent collaborators during an enhanced sync mode. A synchronization service controller 328 handles the receipt and transmission of update communications, whether in the base sync mode or an enhanced sync mode.

It should be understood that although FIG. 3 illustrates the presence evaluator 322, the base sync mode controller 324, the enhanced sync mode controller 326, and the synchronization service controller 328 as components of the collaboration server 306, one or more of these components may be distributed to one or more of the client devices. For example, the collaboration server 306 may execute these components for a smartphone client device, while the client workstations of other collaborators may execute these components within the collaboration environment 300.

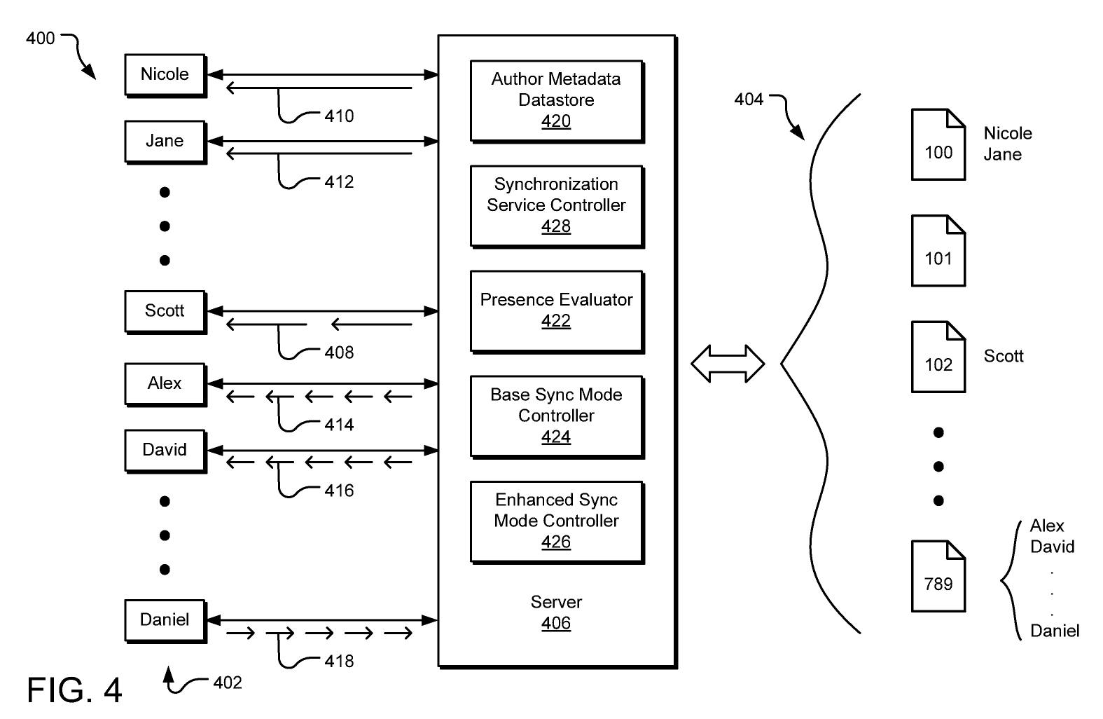

FIG. 4 illustrates an example collaboration environment providing presence-based synchronization at a variety of synchronization rates. Collaborators 402 are concurrently accessing the shared document 404. As with FIG. 3, Nicole and Jane are concurrently accessing page 100, while Scott is accessing page 102 and Alex, David, Daniel and others are accessing page 789. Other collaborators (not shown) may also be accessing the shared document 404. As multiple collaborators are concurrently accessing the shared document 404, albeit in a variety of locations within the shared document 404, the presence-based synchronization operation is in a multi-user mode.

Within the multi-user mode, Daniel's accesses to a page (i.e., page 789) that is concurrently accessed by other collaborators (e.g., David and Alex) causes Daniel's edits to that page to be updated to a collaboration server 406 on an enhanced update communications frequency. As such, Daniel's client device sends update communications describing his edits at the enhanced update communications frequency indicated by the arrow 418). Likewise, Daniel's receipt of edit updates (not shown) by other collaborators on the same page within the shared document 404 (e.g., David and Alex) is also scheduled on an enhanced update communications frequency, as shown by arrows 414 and 416. It should be understood that enhanced update frequencies to and from the collaboration server 406 may differ, depending on the configuration of the collaboration environment 400. In addition, Daniel may nevertheless receive updates from other collaborators on other pages within the shared document 404 at the base update communications frequency (or some other updated frequency that is dependent upon the relative presence of Daniel within the shared documents 404 to those other collaborators).

As shown in FIG. 4, the other collaborators also receive Scott's edit updates at an update communications frequency (as shown by arrows 408, 410 and 412) that is dependent upon the relative presence of each other collaborator to Daniel. Because these collaborators are not present on or accessing the same page (page 102) as Scott, in one implementation, these collaborators received update communications pertaining to Daniel's accesses at a slower rate than David and Alex (e.g., at the base update communications frequency). It should be understood that base update frequencies, whether to or from the server, may be customized on a per user basis, as shown by the different arrow types for arrows 408 and 410.

In one implementation, the collaboration server 406 includes or has access to an author metadata datastore 420, which can store author metadata (including without limitation location data, activity status, communication capability data, etc.) on a per document or document subdivision basis for each collaborator. A presence evaluator 422 determines whether a presence condition is satisfied by one or more other collaborators relative to the current collaborator. A base sync mode controller 424 manages the update communications with the client devices of the concurrent collaborators during a base sync mode, and an enhanced sync mode controller 426 manages the update communications with the client devices of the concurrent collaborators during an enhanced sync mode. A synchronization service controller 428 handles the receipt and transmission of update communications, whether in the base sync mode or an enhanced sync mode.

It should be understood that although FIG. 4 illustrates the presence evaluator 422, the base sync mode controller 424, the enhanced sync mode controller 426, and the synchronization service controller 428 as components of the collaboration server 406, one or more of these components may be distributed to one or more of the client devices. For example, the collaboration server 406 may execute these components for a smartphone client device, while the client workstations of other collaborators may execute these components within the collaboration environment 400.

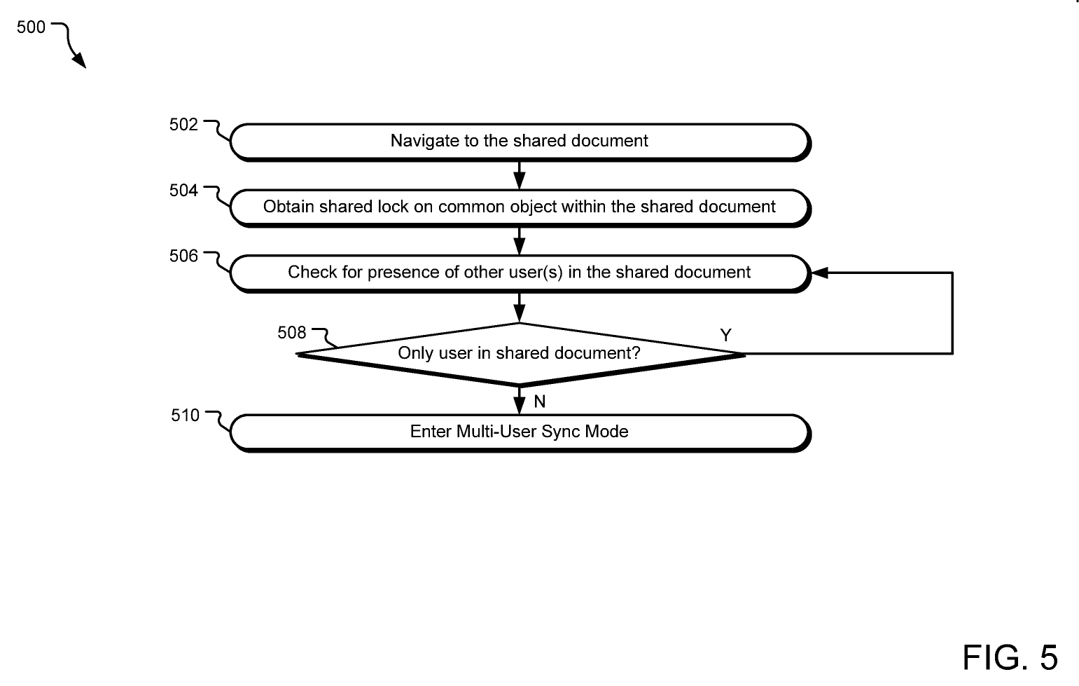

FIG. 5 illustrates example operations 500 for determining between a single user mode and a multi-user mode for presence-based synchronization. If a collaborator is the only collaborator present in a shared (or shareable) document, the collaboration environment may remain in a single user mode. In one implementation, the single user mode may cache the single collaborator's access operations or employ a base or slower update communications frequency. For example, the single user mode may delay update communications to a collaboration server until another user becomes present in the shared document, until the single collaborator saves or exits the shared document, or until another condition is satisfied.

A navigation operation 502 navigates a collaborator to an access location within a shared document. For example, a collaborator may open a document within the collaboration environment and navigate to a page in a notebook of the shared document to read or write (e.g., edit) text or other objects within that page. As a part of accessing the document, a locking operation 504 obtains a shared lock on a common object within the shared document. In one implementation, the collaborator adds an author entry to the author metadata associated with the shared document as part of the locking operation 504.

A presence operation 506 determines whether other collaborators are present within the shared document. If no other collaborators are present within the shared document, a decision operation 508 causes processing to periodically re-check for the presence of other collaborators within the shared document. If the decision operation 508 determines that other users are present within the shared document, a multi-user operation 510 enters a multi-user sync mode.

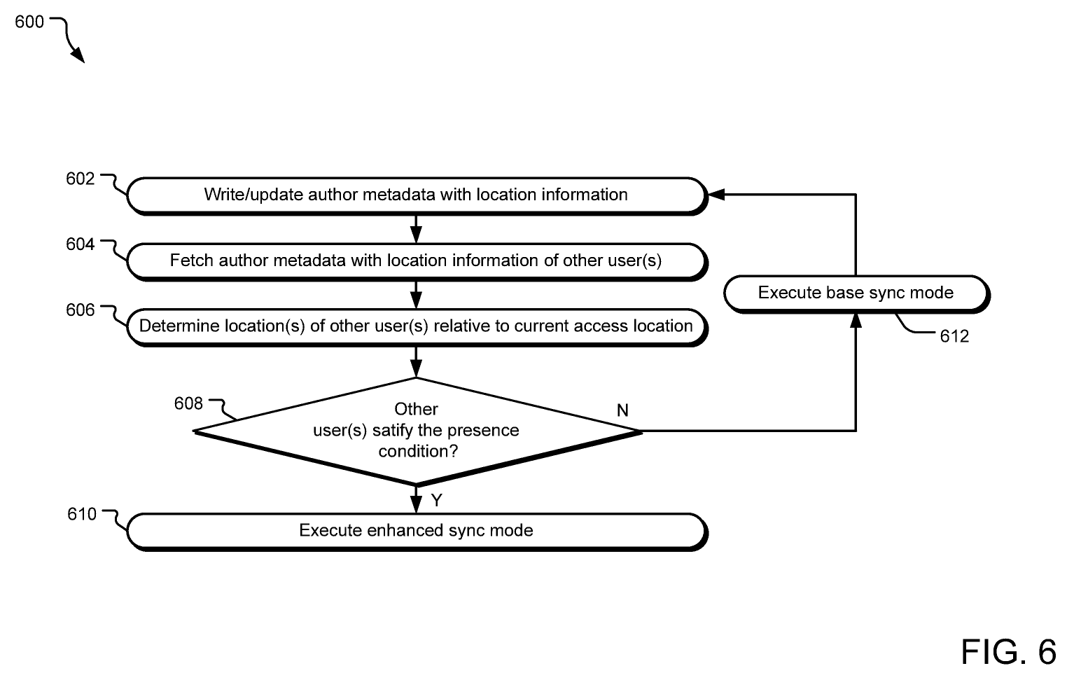

FIG. 6 illustrates example operations 600 for executing a multi-user mode for presence-based synchronization, transitioning from a standard sync mode to a fast sync mode. An author operation 602 accesses the shared document and writes to an author metadata structure associated with the shared document. As each collaborator changes locations within the shared document, the author operation 602 updates the author Meta data to reflect the correct presence information, including the current collaborator's location within the shared document. In one implementation, the author metadata structure is stored in a datastore accessible by the collaboration server and associated with the shared document. The author metadata structure may be accessed by the example metadata access methods provided below, although alternative APIs may be employed:

TABLE 1
Example API for Accessing the Author Metadata

| Method | Description |
|---|---|
| Update Author | Add/update an author's identity and/or |
| (Author ID, Name, XML | presence information (e.g., including the |
| Metadata) | author's location within the shared |
| | document) in the author metadata structure |
| Remove Author | Remove the author from the author |
| (Author ID) | metadata structure |
| Get List of Authors( ) | Return the list of authors and their |
| | presence information (e.g., including their |
| | locations within the shared document) |
| AreThereChanges | Query collaboration server to determined |
| (knowledge token) | whether the author metadata for the shared |
| | document has changed |

A fetching operation 604 reads the author metadata for other collaborators within the shared document. A location operation 606 determines the locations of such collaborators within the shared document based on the author metadata. If a decision operation 608 evaluates a presence condition to determine that one or more other collaborators satisfy a presence condition relative to the current collaborator within the shared document (e.g., on the same page), then the presence-based synchronization executes an enhanced sync mode in an enhanced operation 610. Otherwise, the presence-based synchronization executes a base sync mode in a base operation 612.

In one implementation, a base synchronization frequency (i.e., an update communications frequency) can be set based on predetermined data or algorithmically based on collaboration environment conditions. Likewise, an enhanced synchronization frequency (i.e., another update communications frequency) may be set based on predetermined data (e.g., a table of update communications frequencies accessible by the enhanced sync mode controller) or algorithmically. In one implementation, the enhanced synchronization frequency may be computed based on the number of collaborators in the shared document, the number of update communications within a monitored period, the traffic congestion on the network, etc.

It should be understood that the presence condition can take a variety of forms, and need not be limited to a proximity condition. In one implementation, a presence condition tests whether another collaborator is accessing the same page as the current collaborator. However, in other implementations, the presence condition pertains to other conditions, including without limitation: (1) whether another collaborator is reading or writing to the same page; (2) whether another collaborator is accessing the same paragraph, sentence, document section, image, video, etc.; (3) whether another collaborator is active or inactive within the shared document; (4) whether another collaborator within a logical “distance” within the shared document from the current collaborator; etc. The presence condition may also be a combination of these various conditions.

In one implementation, a difference between the base and enhanced sync modes is that the update communications frequency of a base sync mode is slower than the update communications frequency of an enhanced sync mode. However, in other implementations, a presence condition may suggest that the update communications frequency in an enhanced sync mode be slower than in a base sync mode (e.g., when the presence condition indicates that another collaborator is present on the same page but the collaborator is active in another application, such that the shared document access is executing in the background). In yet other implementations, the enhanced sync mode may increase or decrease the amount of data communicated in a single update communication. For example, a sequence of update communications may communicate only textual edits, omitting or delaying format edits, when many collaborators are present on and actively editing the same page of a shared document.

Furthermore, as previously described, an enhanced sync mode may adjust the sync behavior of update communications from a collaborator and/or to a collaborator. For example, updates frequency may be increased from an actively editing collaborator without increasing the updates received by that collaborator from other collaborators.

In yet another implementation, an enhanced sync mode may influence the frequency of other collaboration operations. For example, certain maintenance operations, such as garbage collection, can be scheduled more or less frequently for an individual collaborator based on the presence information, including whether the collaborator is being synchronized in a base sync mode or an enhanced sync mode. Accordingly, network and CPU load may balanced by delaying maintenance operations while access operations are being synchronized at a faster rate across the network.

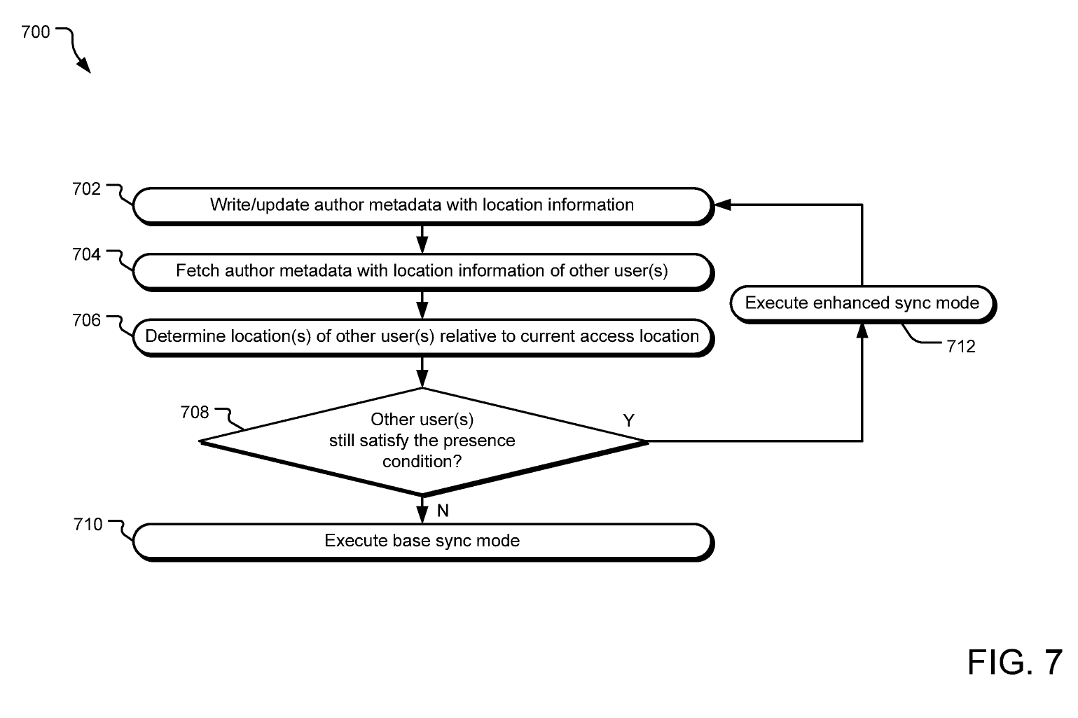

FIG. 7 illustrates example operations 700 for executing a multi-user mode for presence-based synchronization, transitioning from a fast sync mode to a standard sync mode. An author operation 702 accesses the shared document and writes to an author metadata structure associated with the shared document. In one implementation, the author metadata structure is stored in a datastore accessible by the collaboration server and associated with the shared document.

A fetching operation 704 reads the author metadata for other collaborators within the shared document. A location operation 706 determines the locations of such collaborators within the shared document based on the author metadata. If a decision operation 608 evaluates a presence condition to determine that one or more other collaborators still satisfy the presence condition relative to the current collaborator within the shared document (e.g., on the same page), then the presence-based synchronization executes an enhanced sync mode in an enhanced operation 712. Otherwise, the presence-based synchronization executes a base sync mode in a base operation 710.

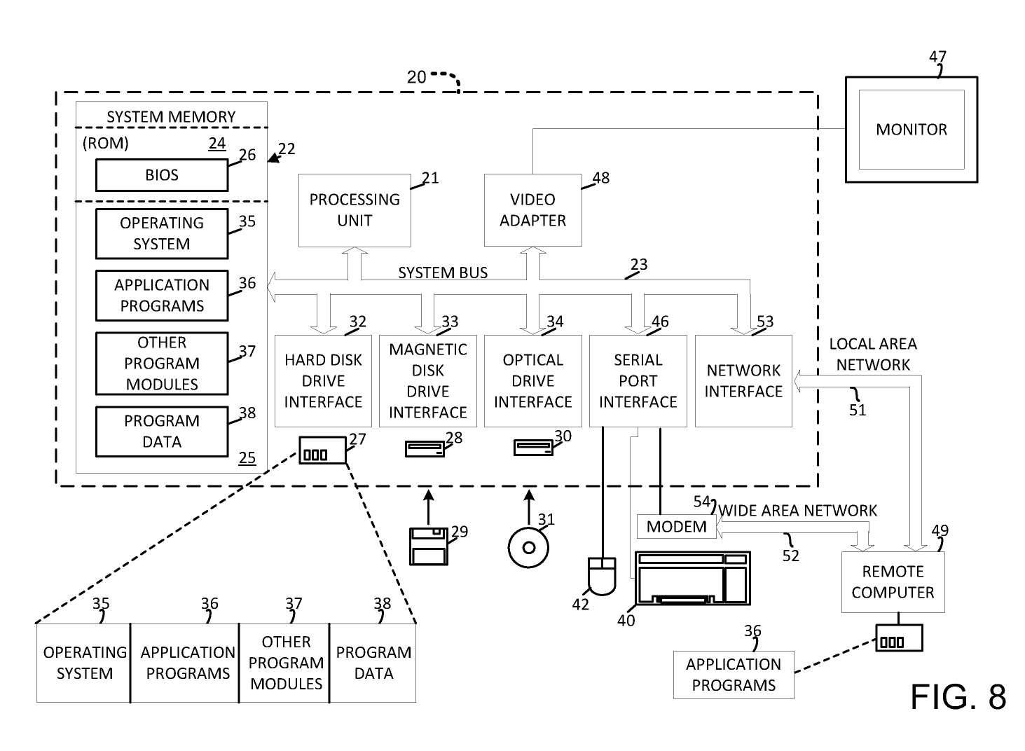

FIG. 8 illustrates an example system that may be useful in implementing the technology described herein. FIG. 8 illustrates an example system that may be useful in implementing the described technology. The example hardware and operating environment of FIG. 8 for implementing the described technology includes a computing device, such as general purpose computing device in the form of a gaming console or computer 20, a mobile telephone, a personal data assistant (PDA), a set top box, or other type of computing device. In the implementation of FIG. 8, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated storage media provide nonvolatile storage of computer-readable instructions, data structures, program engines, and other data for the computer 20. It should be appreciated by those skilled in the art that any type of computer-readable storage media which can store data that is accessible by a computer, such as magnetic cassettes, flash memory cards, digital video disks, random access memories (RAMs), read only memories (ROMs), and the like, may be used in the example operating environment.

A number of program engines may be stored on the hard disk, magnetic disk 29, optical disk 31, ROM 24, or RAM 25, including an operating system 35, one or more application programs 36, other program engines 37, and program data 38. A user may enter commands and information into the personal computer 20 through input devices such as a keyboard 40 and pointing device 42. Other input devices (not shown) may include a microphone, joystick, game pad, satellite dish, scanner, gestures input, touch entry, voice entry, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 4. The logical connections depicted in FIG. 4 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of and communications devices for establishing a communications link between the computers may be used.

In an example implementation, a synchronization service controller, a presence evaluator, a base sync mode controller, an enhanced sync mode controller, and other operators and services may be embodied by instructions stored in memory 22 and/or storage devices 29 or 31 and processed by the processing unit 21. Author metadata, document data, sync mode parameters, and other data may be stored in memory 22 and/or storage devices 29 or 31 as persistent datastores. Further, services, such as a synchronization service, represent hardware and/or software configured to provide service functionality for network-connected systems. Such services may be implemented using a general-purpose computer and specialized software (such as a server executing service software), a special purpose computing system and specialized software (such as a mobile device or network appliance executing service software), or other computing configurations.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method comprising:
determining an update communications frequency between at least two concurrent collaborators of a shared document, wherein the update communications frequency is based on presence information of the at least two concurrent collaborators; and
communicating update communications with at least one of the concurrent collaborators in accordance with the determined update communications frequency, each update communication indicating presence information within the collaboration environment for at least one of the concurrent collaborators.

2. The method of claim 1 wherein presence information of the at least two concurrent collaborators satisfying a presence condition results in a different update communications frequency between the at least two concurrent collaborators than presence information not satisfying the presence condition.

3. The method of claim 1 wherein the determining operation comprises:
determining a faster update communications frequency between the at least two collaborators having relative presence information satisfying a presence condition as compared to an update communications frequency between at least two concurrent collaborators having relative presence information not satisfying the presence condition.

4. The method of claim 1 wherein the determining operation comprises:
evaluating a relative presence condition between the at least two concurrent collaborators.

5. The method of claim 1 wherein the determining operation comprises:
determining a faster update communications frequency if presence information indicates the at least two collaborators are on the same page in the shared document than if the at least two collaborators are on different pages of the shared document.

6. The method of claim 1 wherein presence information of the at least two concurrent collaborators indicates the relative locations of accesses to the shared document by the at least two concurrent collaborators within the shared document.

7. The method of claim 1 wherein presence information of the at least two concurrent collaborators indicates at least one of behavior or status of the at least two concurrent collaborators within the shared document.

8. A system comprising:
a synchronization service controller configured to communicate update communications for synchronizing edits in a shared document among concurrent collaborators of the shared document at different update communications frequencies based on presence information for the concurrent collaborators.

9. The system of claim 8 wherein presence information of the at least two concurrent collaborators satisfying a presence condition results in a different update communications frequency between the at least two concurrent collaborators than presence information not satisfying the presence condition.

10. The system of claim 8 wherein the synchronization service controller is further configured to determine a faster update communications frequency between the at least two collaborators having relative presence information satisfying a presence condition as compared to an update communications frequency between at least two concurrent collaborators having relative presence information not satisfying the presence condition.

11. The system of claim 8 wherein presence information of the at least two concurrent collaborators indicates the relative locations of accesses by the at least two concurrent collaborators within the shared document.

12. The system of claim 8 wherein presence information of the at least two concurrent collaborators indicates activity of the at least two concurrent collaborators within the shared document.

13. The system of claim 8 further comprising:
a presence evaluator configured to evaluate a relative presence condition between the at least two concurrent collaborators.

14. One or more computer-readable storage media encoding computer-executable instructions for executing on a computer system a computer process, the computer process comprising:
communicating update communications for synchronizing edits in a shared document among concurrent collaborators of the shared document at different update communications frequencies based on presence information for the concurrent collaborators.

15. The one or more computer-readable media of claim 14 wherein presence information of the at least two concurrent collaborators satisfying a presence condition results in a different update communications frequency between the at least two concurrent collaborators than presence information not satisfying the presence condition.

16. The one or more computer-readable media of claim 14 wherein the communicating operation comprises:
determining a faster update communications frequency between the at least two collaborators having relative presence information satisfying a presence condition as compared to an update communications frequency between at least two concurrent collaborators having relative presence information not satisfying the presence condition.

17. The one or more computer-readable media of claim 14 wherein the communicating operation comprises:
evaluating a relative presence condition between the at least two concurrent collaborators.

18. The one or more computer-readable media of claim 14 wherein the communicating operation comprises:
determining a faster update communications frequency if presence information indicates the at least two collaborators are on the same page in the shared document than if the at least two collaborators are on different pages of the shared document.

19. The one or more computer-readable media of claim 14 wherein presence information of the at least two concurrent collaborators indicates the relative locations of accesses to the shared document by the at least two concurrent collaborators within the shared document.

20. The one or more computer-readable media of claim 14 wherein presence information of the at least two concurrent collaborators indicates at least one of behavior or status of the at least two concurrent collaborators within the shared document.
